(19) United States
(12) Patent Application Publication
(10) Pub. No.: US 2022/0176399 A1
(43) Pub. Date: Jun. 9, 2022

(54) OVERSPRAY MAT FOR VEHICLE TIRE TREATMENT PRODUCTS

(71) Applicant: Michael Mercier, Harpers Ferry, WV (US)

(72) Inventor: Michael Mercier, Harpers Ferry, WV (US)

(21) Appl. No.: 17/543,431

(22) Filed: Dec. 6, 2021

Related U.S. Application Data
(60) Provisional application No. 63/134,769, filed on Jan. 7, 2021.
(60) Provisional application No. 63/121,285, filed on Dec. 4, 2020.

(51) Int. Cl. B05B 12/32; B08B 17/04

(52) U.S. Cl. CPC B05B 12/32; B08B 17/04

(57) ABSTRACT

A mat apparatus, configured to be placed on the ground at the perimeter of a tire's footprint to protect the driveway or similar surface from chemical overspray, preventing the formation of product rings and blown debris on the surface. The apparatus blocks the overspray from tire detail spray, cleaner, and similar chemical compounds, and provides protection against gravel and dirt blowout/up from pressurized water flow, as well as prevents sponges, rags and scrub brushes from picking up particles on the ground that could scratch finished surfaces when washing tires and rims on vehicles. The mats are preferably equipped with an oleophobic coating to enable easy cleaning of the mats for reuse. The material with which the mats are manufactured is preferably flexible to enable one to roll them up for storage when not in use.

This application is a non-provisional patent application of provisional patent application No. 63/134,769, filed on Jan. 7, 2021, and of provisional patent application No. 63/121,285, filed on Dec. 4, 2020, and priority is claimed thereto.

### FIELD OF THE PRESENT INVENTION

The present invention relates to the field of vehicle maintenance, and more specifically relates to an overspray mat configured to be placed around the base of tires of a vehicle to ensure the prevention of overspray of conventional automotive protection, cleaning, and treatment products from contacting adjacent surfaces.

### BACKGROUND OF THE PRESENT INVENTION

Conventionally, during the treatment of wheels, tires, brake calipers, and similar wheel-related components of vehicles, an assortment of sprays are often employed, including lubricants, sealants, protectants, paints, cleaners, degreasers, and tire shining solutions. Such products contain a variety of chemicals, a majority of which are hazardous to the environment.

Unfortunately, such chemicals can be difficult to clean off of surrounding surfaces such as the floor of the garage, the driveway, the street, or similar surfaces. Additionally, when used outdoors as is generally advised, these chemicals can leave oil-slick stains or similar blemishes on pavement, which leads to harmful runoff to nearby bodies of water.

Some body shops and vehicle cleaning stations employ disposable paper to prevent the overspray from contacting adjacent shop surfaces. However, this method is not very sustainable and ultimately cannot be reused. Additionally, some solutions leak through paper. Others have used shop rags and towels to cover surfaces to protect them from overspray; however these are often difficult to get clean, and the overspray can also soak through such fabrics.

If there were a way in which vehicle owners working on their vehicles at home, as well as shop owners and car detailing facilities could protect the floor, ground, and adjacent surfaces from the detrimental effects of chemical overspray via a reusable apparatus, the use of such chemicals in a cleanly manner on the tires, rims, and wheel-well components of vehicles could be facilitated and expedited.

Thus, there is a need for a new overspray mat apparatus configured to circumscribe the tire footprints of the vehicle so as to protect the adjacent surfaces from overspray. Such an apparatus is preferably equipped with an oleophobic coating to ensure that the mats may be easily cleaned after use to ensure that they may be reused without causing harm to the environment or requiring excessive cleaning of shop, garage, pavement, or similar surfaces.

### SUMMARY OF THE PRESENT INVENTION

The present invention is a reusable mat apparatus configured for use around the tires of vehicles to aide in the prevention of chemical overspray commonly found to occur during conventional maintenance and cleaning processes. The apparatus is equipped with at least one groove configured to facilitate the mat's adherence to the tires of the vehicle such that minimal chemical overspray may escape the coverage of the mats.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 exhibits a view of the apparatus of the present invention as seen from the top, detailing the wheel footprint of the present invention.

FIG. 2 shows a flow chart detailing the process of use of the present invention by a user.

FIG. 3 depicts a preferred embodiment of the apparatus of the present invention as shown from the top.

FIG. 4A exhibits a view of a preferred embodiment of the apparatus of the present invention equipped with a mounting mechanism in the form of a swivel tab to facilitate storage of the apparatus when not in use.

FIG. 4B exhibits a view of a preferred embodiment of the apparatus of the present invention equipped with a mounting mechanism in the form of a grommet to facilitate storage of the apparatus when not in use.

FIG. 5A depicts an alternate embodiment of the present invention equipped with telescoping joints or sizing tracks, allowing the apparatus to telescope open and closed for more compact storage and for quickly sizing the apparatus to the target tire.

FIG. 5B shows an alternate embodiment of the present invention, showing numerous telescoping joints for quickly sizing the apparatus to the target tire.

FIG. 6 depicts a view of a side of an alternate embodiment of the present invention, detailing the sloped nature (wedge-shape) of the mat apparatus.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a protective apparatus configured to protect floor surfaces from the buildup of chemical overspray commonly employed in the cleaning, detailing, and maintaining of vehicles, primarily relating to tire, wheel, and brake system care. The preferred embodiment of the present invention is a mat (10) which is configured to be deployed at the base of tires of the vehicle. As such, multiple iterations of the mat (10) of the present invention are preferably employed to provide adequate coverage of ground and floor surfaces adjacent to and surrounding the tires during treatment/cleaning.

The mats (10) of the present invention are preferably equipped with a top surface (20) having an oleophobic coating or similar feature which is configured to facilitate cleaning of the mats (10) easily with a damp cloth. As such, all embodiments of the present invention are preferably designed to be easily stored and reused.

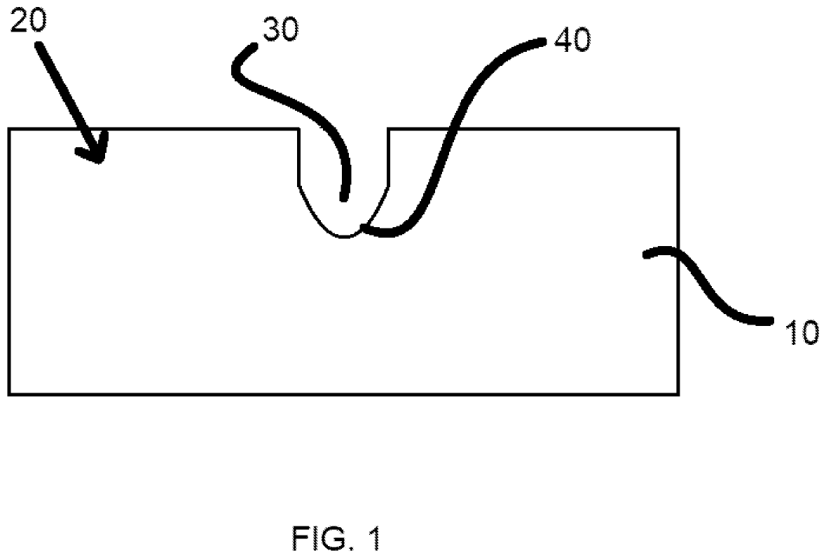

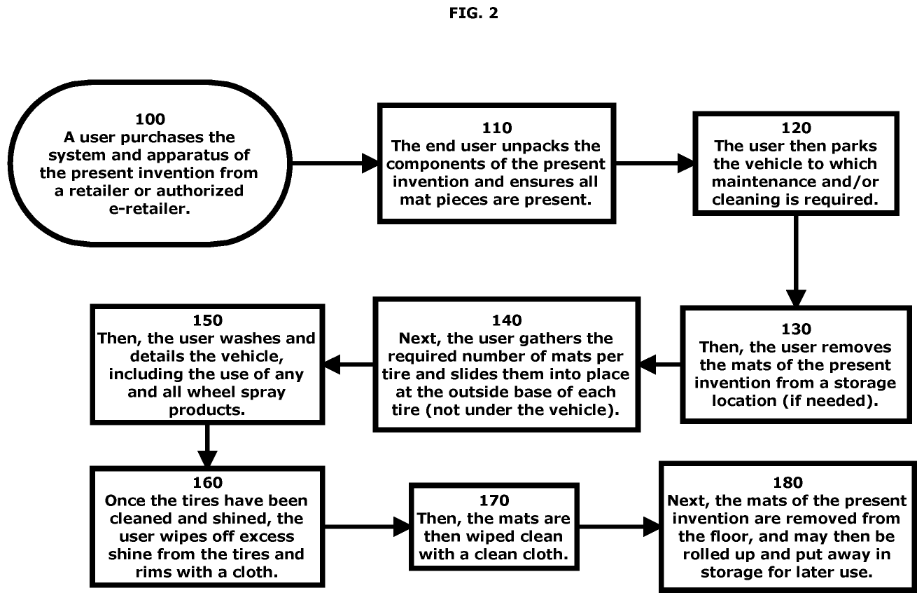

Each iteration of the mat (10) of the present invention is configured to slide into place at the bottom of the tire where the tire sits on the pavement, gravel driveway, concrete driveway, or yard while the vehicle remains stationary. It should be noted that only one mat per tire is needed as the mat size protects the required areas surrounding each tire as shown in FIG. 2. As shown in the figures, a void (30) is present which amounts to a space where the mat (10) may slide up to and against the tire. The void (30) is formed by a tire-shaped detent (40) which is cut out of the mat (10) as shown in FIG. 1.

Presently, it is envisioned that the vehicle remains stationary for convenience of use of the present invention. As such, use of the present invention does not require the user to drive the vehicle atop the mats (10) for use.

Alternate embodiments of the present invention may employ a block which is configured to be disposed within the void (30) to provide an even more complete coverage system. However, if such a block is used, the user must then drive the vehicle atop the mats (10) for them to remain effective.

It should be understood that the present invention may be utilized for any tire size. The overall height of the mats (10) of the present invention preferably range between 0.01 mm to 1.77 mm. The width of each mat (10) preferably ranges between six inches and sixteen inches as needed. The length of each mat (10) preferably ranges between two feet and five feet depending on the vehicle tires to which the mat (10) is to be employed. While the differences in length may seem vast, customers are preferably provided the option to customize the size desired. Larger mats (10) are often needed if one works in a particularly windy territory where overspray is of greater concern.

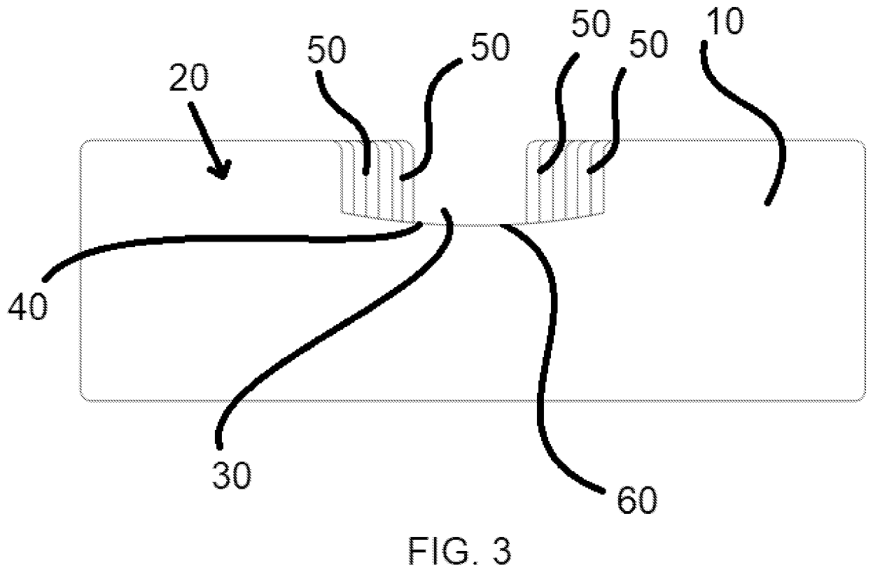

The process of installation and use of the system and apparatus of the present invention, as shown in FIG. 3, is preferably as follows:
1. A user purchases the system and apparatus of the present invention from a retailer or authorized e-retailer. (100)
2. The end user unpacks the components of the present invention and ensures all mat pieces are present. (110)
3. The user then parks the vehicle to which maintenance and/or cleaning is required. (120)
4. Then, the user removes the mats of the present invention from a storage location (if needed). (130)
5. Next, the user gathers the required number of mats per tire and slides them into place at the outside base of each tire (not under the vehicle). (140)
6. Then, the user washes and details the vehicle, including the use of any and all wheel spray products. (150) Products may include, but are not limited to: Tire shine, tire cleaning solutions, brake cleaners, and the like.
7. Once the tires have been cleaned and shined, the user wipes off excess shine from the tires and rims with a cloth. (160)
8. Then, the mats are then wiped clean with a clean cloth. (170) The mat may be cleaned using the same rag used to wipe the excess tire shine off the rim or tire. The detailer could alternately dedicate a cloth to the cleaning of the mat if desired.
9. Next, the mats of the present invention are removed from the floor, and may then be rolled up and put away in storage for later use. (180)

Alternate embodiments of the present invention may exhibit differently shaped voids (30) to accommodate differing types of tire shapes as needed. The following void shapes are presently envisioned:
Curved: best for daily drivers and vehicles with tires that have moderate to aggressive tread.
Straight line: works best with tires that have a large footprint, hot rods and customs, (wide tires).
V-shape, 3 sided, and half Octagon: works best with off road tires with aggressive tread. Similarly, motorcycles may be best suited for use of the V-shaped void.

It should be noted that alternately shaped voids may be present in other alternate embodiments of the present invention without venturing from the essence of the present invention.

It should be understood that the present invention is configured to accommodate all presently available tire sizes via differently sized embodiments of the present invention. As such, the present invention covers 18-wheeler tire sizes and the inherent design measurements would allow the mat (10) to be stretched to cover a tire with 12″ of rubber on the ground.

Materials used in the composition of the mats (10) of the present invention may vary. However, it is envisioned that one or more of the following materials be employed in the manufacturing of the preferred embodiment of the present invention:
1. Fabric vinyl
2. Rubber
3. Wood
4. Plastic
5. PVC Vinyl
6. Vinyl
7. Rigid Vinyl
8. Absorbent matting
9. Silicone
10. Waterproof material
11. Cardboard
12. Magnet
13. Nylon
14. Polyester
15. Cotton
16. Carbon fiber
17. Stainless steel
18. Aluminum
19. Steel
20. Flex seal
21. Foam
22. Anti-slip
23. Sheet metal
24. Fiberboard
25. Composite Material
26. Mud Brick
27. Fiberglass
28. Kevlar
29. Composite Honeycomb
30. Engineered Bamboo
31. Fiber reinforced Polymer
32. Polymer Matrix Composites
33. Metal matrix composites
34. Ceramic Matrix composites

The preferred materials employed in the present iteration of the preferred embodiment of the present invention includes Fabric Vinyl, PVC Vinyl, or other similar waterproof materials.

In preferred embodiments of the present invention, perforated lines (50) are present on the mat (10) within the tire-shaped detent (40) as shown in FIG. 3. The perforated lines (50) enable the end-user to trim-to-fit the present invention to easily accommodate differently sized tires as needed. In some embodiments, the perforated lines (50) may solely be present as a graphic embedded into the material of the mat (10) to provide a guide by which the mat (10) may be trimmed. There are preferably a total of 10 perforated lines (50) present on the mat, five on each side of the tire-shaped detent (40) to provide for mirrored or equal trimming of each side of the tire-shaped detent (40) to maintain symmetry.

Additionally, in preferred embodiments of the present invention such as that depicted in FIG. 3, a curved sidewall portion (60) is present. The curved sidewall portion (60) is configured to accommodate tires with differing air pressure, as tires with lower pressure tend to mushroom out slightly at the bottom of the tire when stationary. The curved sidewall portion (60) enables the mat (10) to rest flush against the sidewall of the tire when in position for tire treatment/protectant/shine application. Additionally, the curved sidewall portion (60) helps to accommodate tires of differing temperatures, as tires which have been warmed up during use have a greater tire pressure than tires which are cold.

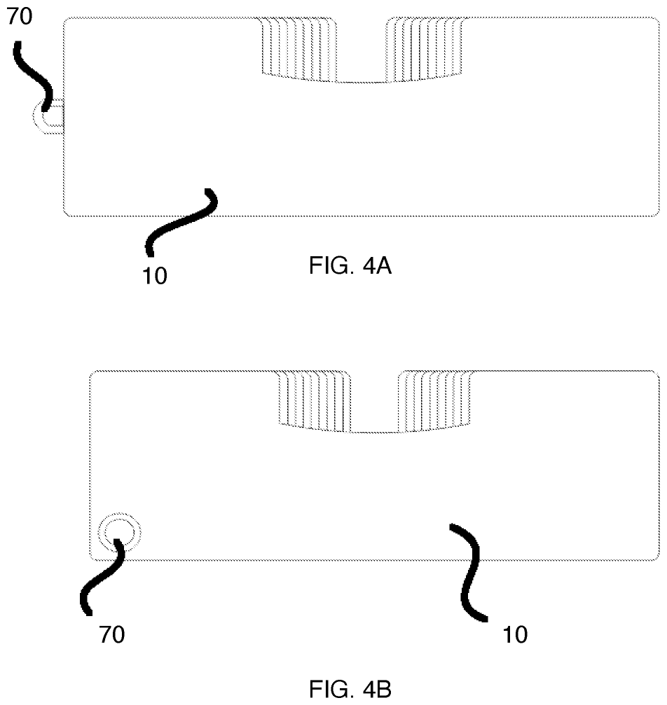

It should be noted that some embodiments of the present invention are preferably equipped with one or more mounting mechanisms (70) configured to facilitate the mounting of the present invention to a wall, hook, or similar storage location when not in use. Two variations of the mounting mechanisms (70) can be seen in FIG. 4A and FIG. 4B, however other conventional means of mounting the apparatus to a wall, hook, or similar mounting location are envisioned.

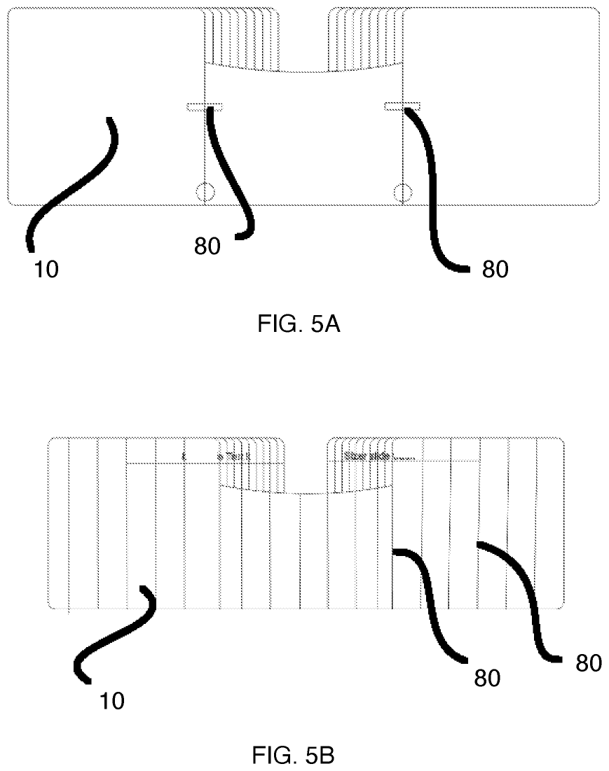

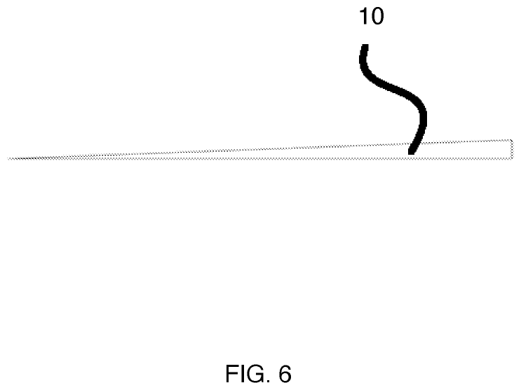

Alternate embodiments of the present invention include a form of mat (10) which is equipped with a telescoping sizing tracks (80) as depicted in FIG. 5A and FIG. 5B. In such embodiments, a sizing slide tracks (80), with or without locking positions, can be added to the mat on one, two, three, and/or four sides to allow the sizing edge(s) to slide for fitment to different sized tires. The slide track can be controlled manually and or by electronic, spring(s), swivel(s), hinge(s,) air, oil, liquid(s), heat sensor(s), gas system, telescoping system(s), and or pressure system(s) of any sort. This system could include manual lock(s) and or sensor(s) to stop the track at desired tire size(s), to work as a single system, and/or be designed into multiple systems. Additionally, such a telescoping sizing tracks may be fully powered by solar, batteries, hardwired to A/C power, utilizing heat from driveway, and/or rechargeable/disposable battery pack. Further, such alternate embodiments may be controlled by Bluetooth™, manually controlled, and/or remote controller devices. The locking system can be designed to have multiple locking positions, allowing the mat (10) to lock at the desired (extended or retracted) position. The sizing slide track (80) can also be made to be fixed into the mat and/or as a separate piece that may be placed into and/or on the mat as a form of secondary insert. This system could also be designed by use of holes in the mat to adjust to different tire sizes and or be made as a multi-assembly design. As depicted in FIG. 5A and FIG. 5B, each vertical line is a representation of a telescoping joint (90), allowing the plastic mat (10) to telescope between open and closed positions.

Furthermore, in other alternate embodiments of the present invention, the mat (10) may be accompanied by, or integrated into, a form of block. The block can be made of solid and or inflatable devices. The inflatable devices can be filled using air, gas, compressed air, C02, Nitrogen and or other gasses or liquids for pressurizing systems. The inflatable block can be self-inflation feature, accomplished via an integrated Co² cartridge build in to the system, valve for filling air, nitrogen, and/or self-inflatable. The inflatable device can be controlled manually, by Bluetooth™ remote activation, and/or from RF remote controller devices. The block can be added as a single piece and/or built and fixed into the mat (10) as one unitary piece. The inflatable block can be designed with a reservoir and or chamber to store gases and or liquids when not inflated.

It should be understood that in all preferred embodiments of the present invention, the design of the mat (10) of the present invention is configured to allow the customer or end user to cut out and remove excess material at the graphically indicated or perforated line(s) provided using a knife or scissors to allow for a more perfect fitment to the tire. The change in curvature depth also allows for better tire fitment.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. An overspray mat for the protection of a floor around tires of a vehicle comprising:
a planar surface, said planar surface having a generally rectangular shape;
wherein said planar surface has a top side and a bottom side;
wherein said top side is equipped with an oleophobic coating;
wherein said planar surface has four edges;
a tire-shaped detent, said tire-shaped detent disposed on one of said four edges;
wherein said tire-shaped detent has three sides, forming a void;
perforated lines, said perforated lines disposed along two of said three sides of said cutout;
wherein said perforated lines are parallel;
wherein said perforated lines facilitate removal of portions of the planar surface to expand the dimensions of said void;
wherein said perforated lines are stepped such that the perforated lines disposed nearest a center of said void are disposed on material which is thinner than those disposed nearest the perimeter of said tire-shaped detent; and
wherein a shape of said void is selected from the following group: curved, straight, V-shaped, and half-octagon.
